(19) United States
(12) Patent Application Publication
(10) Pub. No.: US 2012/0124649 A1
(43) Pub. Date: May 17, 2012

(54) Attachment method and system for Id-Loc-Split in an NGN

(75) Inventors: Ningxia Zhao, Shenzhen (CN); Qiang Wu, Shenzhen (CN); Bo Wu, Shenzhen (CN)

(73) Assignee: ZTE CORPORATION, Shenzhen, Guangdong (CN)

(21) Appl. No.: 13/257,921

(22) PCT Filed: Nov. 16, 2009
(86) PCT No.: PCT/CN2009/074963

§ 371 Date: Sep. 20, 2011

(30) Foreign Application Priority Data
Jul. 17, 2009 (CN) 200910157947.2

(51) Int. Cl. G06F 21/00

(52) U.S. Cl. 726/4

(57) ABSTRACT

This disclosure provides an attachment method and system for ID-Loc-Split in an NGN, to implement an attachment process for an IPSPLIT-based ID-Loc-Split in an NGN, which can be combined well with various existing functional entities in the NGN, wherein a user identification is represented by a Host ID, and during the attachment process, a user is located through the Host ID, and during an authentication process, a key authentication method is provided to the Host ID; when location of the user changes due to its mobility or multihoming, the Host ID does not change; the application and connection of the transport layer is bound to the user identification, such that the application and connection will not be interrupted, and an ongoing communication session and service will not be interrupted, which guarantees the security of attachment and seamless handover when the location of a host changes due to its mobility or multihoming.

### TECHNICAL FIELD

The disclosure relates to the field of communication technologies, and more particular, to a method and system for implementing an attachment process for Identification-Location Split (ID-Loc-Split) in a Next Generation Network (NGN).

### BACKGROUND

In TCP/IP protocol of the Internet, an IP address has double functions: as a location identification of a host network interface of the network-layer communication terminal in the network topology, and as an identification of a transport-layer host network interface. With the evolution of the NGN, the problems of mobility and multi-homed host have become more and more common. This drawback of semantic overload for IP address becomes increasingly striking. When a host IP address changes, not only the route is to change, but also the host ID of the communication terminal is also to change. Change of the ID causes interruption of the connection and application.

FIG. 1 is a diagram illustrating a functional framework of an existing NGN system, wherein respective functional entities function as follows:

a Transport User Profile Functional Entity (TUP-FE) is used for saving user information regarding the transport layer;

a Transport Authentication and Authorization Functional Entity (TAA-FE) is used for providing a transport layer authentication and authorization function to authenticate and authorize the network access of the user based on the user information;

an Access Management Functional Entity (AM-FE) is used for translating a network access request initiated by the user and transmitting the requests to an NAC-FE for assigning an IP address and other network configuration parameters;

a Transport Location Management Functional Entity (TLM-FE) is used for registering the IP address assigned to the user and other network location information provided by the NAC-FE; and

a Network Access Configuration Functional Entity (NAC-FE) is used for assigning an IP address to a user terminal, and meanwhile, the NAC-FE may be used for assigning other network configuration parameters (for example, an address of a DNS server, an address of a signaling proxy, etc.) to the user terminal.

A user attachment process based on the existing NGN system functional framework is illustrated in FIG. 2.

The authentication and authorization process (steps 101-104): a UE transmits an authorization request to the Transport Authentication and Authorization Functional Entity (TAA-FE) through the Access Management Functional Entity (AM-FE), wherein the TAA-FE stores a user identifier and a certificate. Herein the user identifier may be a globally unique IP address or an identifier configured by the transport layer; the TAA-FE returns the authentication and authorization response to the user through the AM-FE, to complete the authentication and authorization process.

The IP configuration process (steps 201-206): the IP configuration process may be completed through a Dynamic Host Configuration Protocol (DHCP) or through an self-configuration process. FIG. 2 illustrates an IP address configuration through the Dynamic Host Configuration Protocol (DHCP).

Transport location management process (steps 301-302): the Transport Location Management Functional Entity (TLM-FE) performs transport location query by searching a Service Control Function (SCF). The SCF each time obtains the unique IP address used in current transportation of the user. When the user moves or the location of the user changes, it is required to re-perform the above authentication and authorization attachment process so as to obtain a new IP address, which therefore increases network load and affects the normal execution of a service or an application.

### SUMMARY

Therefore, the main objective of the disclosure is to provide an attachment method for ID-Loc-Split in an NGN, for implementing a secure attachment of ID-Loc-Split in the NGN.

In order to achieve the above objective, the technical solution of the disclosure is implemented in the following ways.

An attachment method for ID-Loc-Split in an NGN, the method comprises: performing a network attachment process for a User Terminal (UE) through an ID-Loc-Split Mapping Function Entity (ILSM-FE), wherein a user identification (Host ID) is used during an authentication and authorization process, the Host ID is a public key for uniquely identifying a user, the ILSM-FE performs authorization to the Host ID based on security parameters, the method specifically comprises steps of:

A: performing authentication and authorization to a user identity through the ILSM-FE during the authentication and authorization process;

B: assigning an IP address to the user terminal through an IP address configuration process; and

C: when location of a user changes, responding to an ID/LOC mapping request of the user identification and location identification, and performing a mapping between the Host ID and the IP address by the ILSM-FE.

Further, in step A, when a Transport Authentication and Authorization Functional Entity (TAA-FE) receives an authorization request transmitted from an Access Management Functional Entity (AM-FE), transmitting a request message for querying authorization information from the TAA-FE to the ILSM-FE; wherein the request message for querying authorization information includes security parameters required for authenticating the user identity; performing authentication and authorization to the Host ID by the ILSM-FE based on the security parameters and transmitting a result of authentication and authorization from the ILSM-FE to the TAA-FE through a response message for querying authorization information.

Further, in step C, initiating the ID/LOC mapping request to the ILSM-FE by the user terminal, wherein the request includes a new IP address of the user; and transmitting a result of mapping from the ILSM-FE to the user terminal after the ILSM-FE performs the mapping between the Host ID and the IP address.

Further, in step C, firstly initiating the ID/LOC mapping request to a TLM-FE by the user terminal, wherein the request includes a new IP address of the user; and forwarding the ID/LOC mapping request from the TLM-FE to the ILSM-FE; and

after the ILSM-FE performs the mapping between the Host ID and the IP address, transmitting a result of mapping to the user terminal through the ILSM-FE.

Further, in step C, initiating the ID/LOC mapping request to the ILSM-FE by the TLM-FE, wherein the request includes a new IP address of the user; transmitting an ID/LOC mapping response from the ILSM-FE to the TLM-FE after the ILSM-FE performs the mapping between the Host ID and the IP address.

Based on the above method, the disclosure further provides an attachment system for ID-Loc-Split in an NGN, comprising a User Terminal (UE), an Access Management Functional Entity (AM-FE), a Network Access Configuration Functional Entity (NAC-FE), a Transport Location Management Functional Entity (TLM-FE), a Resource Admission Control Function (RACF), a Service Control Function (SCF), and a Transport Authentication and Authorization Functional Entity (TAA-FE), the system further comprises:

an ID-Loc-Split Mapping Function Entity (ILSM-FE), configured to perform authentication and authorization to a user identification (Host ID) based on security parameters transmitted from the TAA-FE; when the location of a user changes, the ILSM-FE performs a mapping between the Host ID and an IP address based on an ID/LOC mapping request transmitted from the UE or the TLM-FE.

By applying the disclosure, a secure attachment method for ID-Loc-Split in an NGN can be implemented. The mapping between the identification (Host ID) and location identification (LOC) is stored in the ILSM-FE. This mapping may be one-to-one, or one-to-multiple; in case of one-to-multiple, when a user hands over from one IP address to another IP address during a communication process, the SCF just needs to search the ILSM-FE based on the user identification (Host ID) and then update the mapping between the Host ID and the LOC, without re-performing the authentication attachment process. The disclosure enables the authentication attachment process to be independent from the location of a user, which guarantees that the ongoing application and service will not be interrupted when the location of the user changes and thereby guarantees seamless handover of the communication.

### BRIEF DESCRIPTION OF THE DRAWINGS

FIG. 1 is a diagram illustrating a functional framework of an NGN system;

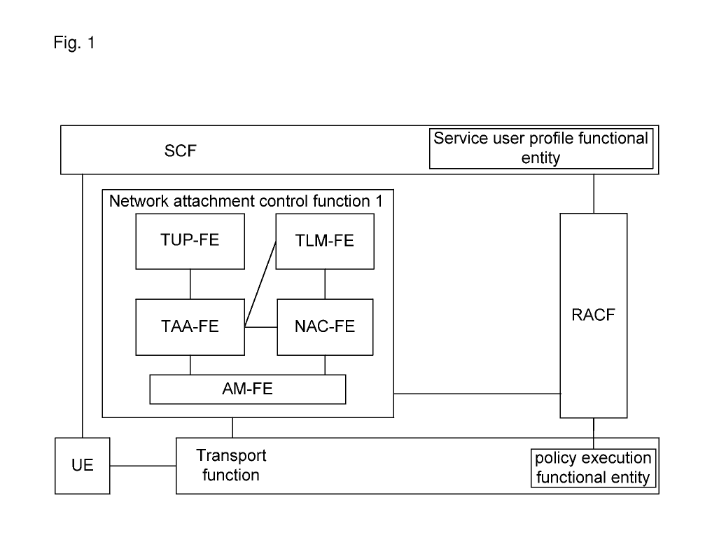

FIG. 2 is a schematic diagram illustrating a conventional attachment process in an NGN;

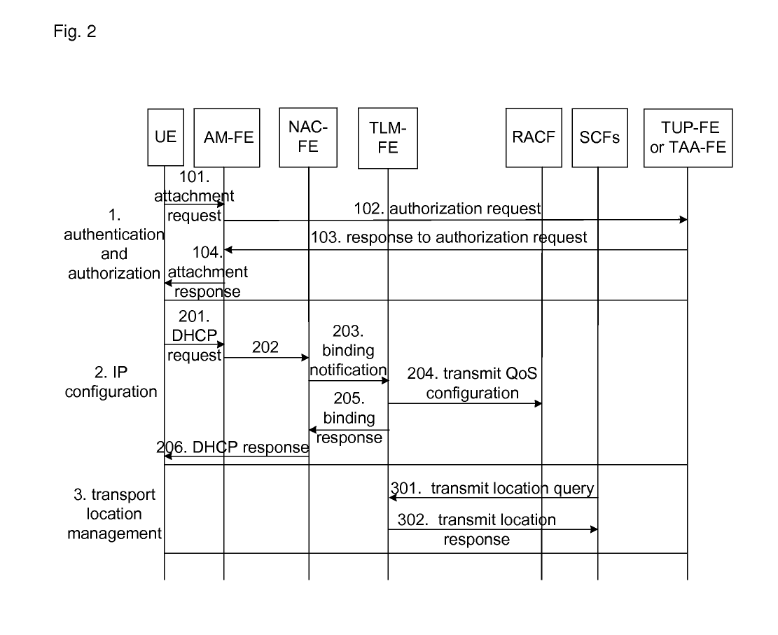

FIG. 3 is a diagram illustrating a functional framework of an NGN system for implementing an ID-Loc-Split attachment process according to the disclosure;

FIG. 4 is a schematic diagram illustrating an ID-Loc-Split attachment process in an NGN according to the disclosure (wherein a user terminal initiates a mapping request without the participation of a network gateway);

FIG. 5 is a schematic diagram illustrating an ID-Loc-Split attachment process in an NGN according to the disclosure (wherein a user terminal initiates a mapping request with the participation of a network gateway); and

FIG. 6 is a schematic diagram illustrating an ID-Loc-Split attachment process in an NGN according to the disclosure (wherein a network side initiates a mapping request).

### DETAILED DESCRIPTION

In order to make the objective, technical solution, and advantage of the disclosure much clearer and easier to understand, the disclosure is further described in detail through the following embodiments with reference to the accompanying drawings.

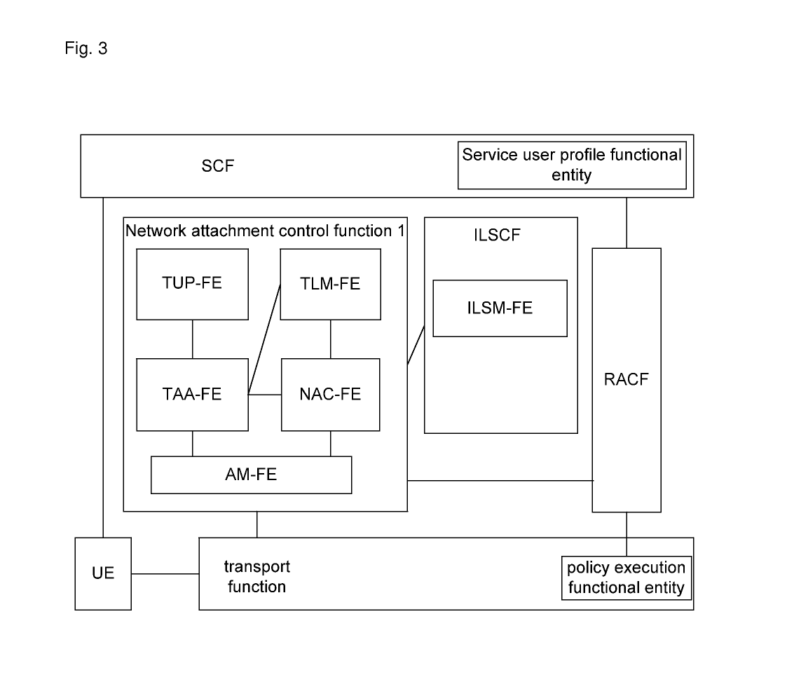

FIG. 3 is a diagram illustrating a functional framework of an NGN system for implementing an ID-Loc-Split attachment method in the NGN according to the disclosure. Different from the functional framework of an existing NGN system, the disclosure adds an ID-Loc-Split Control Function (ILSCF) based on the transport control function of the NGN, so as to implement the ID/Loc control function. The ILSCF has an ID-Loc-Split Mapping Function Entity (ILSM-FE) as a mapping database entity of a user ID-Loc-Split system in the NGN, the ILSM-FE is used for mapping the user identification (Host ID) to one or more locations (LOC). This disclosure merely uses the location attributes of the IP address to identify the location (LOC) of the user; the ILSM-FE stores parameters associated with the user; and meanwhile, an array of random numbers for authorization is provided by the ILSM-FE, which is available for the user terminal to calculate an encryption key. In the ILSM-FE, the binding is also performed by mapping between the Host ID and the LOC.

A basic idea of this disclosure is as follows: when the user performs network attachment, a Host ID is used as the user identification during the authentication and authorization process, and the user attachment process is performed through an ID-Loc-Split Mapping Function Entity (ILSM-FE). The ILSM-FE performs authentication and authorization to the user identification (Host ID). Through the Access Management Functional Entity (AM-FE), the User Terminal (UE) performs a DHCP request through the AM-FE and obtains an IP address through the NAC-FE; the mapping between the Host ID and the IP address is performed through the ILSM-FE.

This disclosure preferably selects three manners for implementing the ID-Loc-Split terminal attachment. Their main difference lies in the mapping processs between an identification and a location. The three manners are implemented as follows.

### Embodiment 1

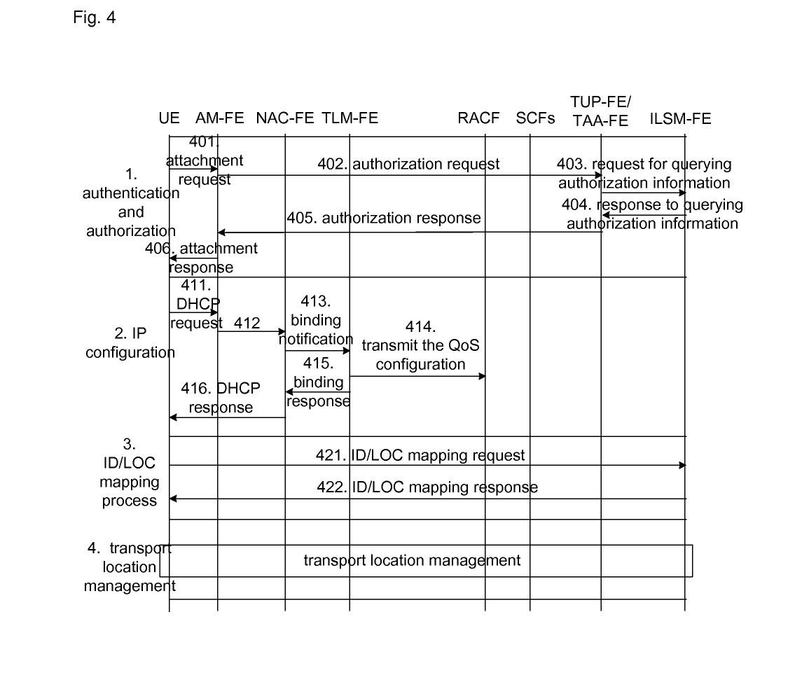

FIG. 4 is a schematic diagram illustrating an ID-Loc-Split terminal attachment process in an NGN system with the terminal initiating a mapping request and without the participation of a gateway. The specific steps are specified as follows.

(1) The authentication and authorization process (steps 401-406):

Step 401: transmitting an attachment request from a UE to an AM-FE to request network attachment.

Step 402: transmitting an authorization request message from the AM-FE to a TAA-FE after receiving the attachment request from the UE, wherein the authorization request message includes a user identification (Host ID) and security parameters (e.g. key and half key for authenticating the user identity) which are both required for authenticating the user identity.

Step 403: transmitting a request message for querying authorization information from the TAA-FE to the ILSM-FE, the request message for querying authorization information includes the Host ID and the security parameters which are both required for authenticating the user identity.

Step 404: performing authentication and authorization to the user identity by the ILSM-FE based on the security parameters and transmitting a result of authorization from the ILSM-FE to the TAA-FE through a response message for querying the authorization information, the response message includes the result of authorization (success or failure).

In a preferred embodiment of the disclosure, the Host ID is a public key for uniquely identifying a user, and the ILSM-FE performs authentication to the Host ID based on the security parameters according to a key algorithm, thereby guaranteeing security of the attachment process.

Step 405: transmitting an authorization response including the result of authorization from the TAA-FE to the AM-FE.

Step 406: transmitting an attachment request response message including the result of authorization from the AM-FE to the UE.

(2) The IP address configuration process (steps 411-416):

The IP configuration process may be performed through self-configuration or through the DHCP. In this embodiment, the IP address is obtained through the DHCP.

Step 411: transmitting a DHCP request from the UE to the AM-FE to request to assign an IP address.

Step 412: forwarding the DHCP request from the AM-FE to an NAC-FE.

Step 413: transmitting a binding notification message from the NAC-FE to a TLM-FE.

The binding notification message includes a temporary address and other information that is associated with transportation such as a logic address and a physic port address which are assigned by the NAC-FE to the UE.

Step 414: transmitting policy information such as Quality of Service (QoS) configuration from the TLM-FE to an RACF.

Step 415: transmitting the binding information of the user address from the TLM-FE to the NAC-FE through the binding response message.

Step 416: transmitting the new IP address from the NAC-FE to the UE through a DHCP response message.

(3) The ID/LOC mapping process (steps 421-422):

When the location of a user changes due to its mobility or multihoming, an address update is performed through the ILSM-FE; and after the user obtains the new IP address, the new IP address is mapped to the Host ID in the ILSM-FE. During this process, the user identification (Host ID) does not change. The ID/LOC mapping process is specified as below.

Step 421: transmitting an ID/LOC mapping request from the UE to the ILSM-FE, wherein the message includes a new IP address of the user.

After obtaining the IP address, the mapping between the Host ID and the IP address is performed in the ILSM-FE, the mapping process may be voluntarily initiated by the terminal or by the network side. In this embodiment, the mapping process is voluntarily initiated by the UE.

Step 422: transmitting an ID/LOC mapping response from the ILSM-FE to the UE.

After completing the mapping between the Host ID and the LOC, the ILSM-FE transmits the ID/LOC mapping response message to the UE.

When the user is in mobility or multihoming scenario, the same user identification (Host ID) at a same time or in different time may correspond to a plurality of IP addresses. In other words, the mapping between the user identification (Host ID) and the IP address(es) in a database of the ILSM-FE may be one-to-one or one-to-multiple. It is different from the scenario that in a general NGN network, only one IP address corresponds to one user in the TLM at a same time.

(4) The transport location management process:

The SCF requests the ILSM-FE for the location information of the current user, and the ILSM-FE reports the location LOC where the user is currently located to the SCF. In this process, the SCF searches for the location LOC where the user is currently located based on the user identification (Host ID). The SCF firstly finds the ILSM-FE, and then finds the location LOC where the user is currently located based on the mapping between the Host ID and the LOC. It is different from searching for the current IP address of the user by the SCF directly through the TLM-FE in a general NGN network.

### Embodiment 2

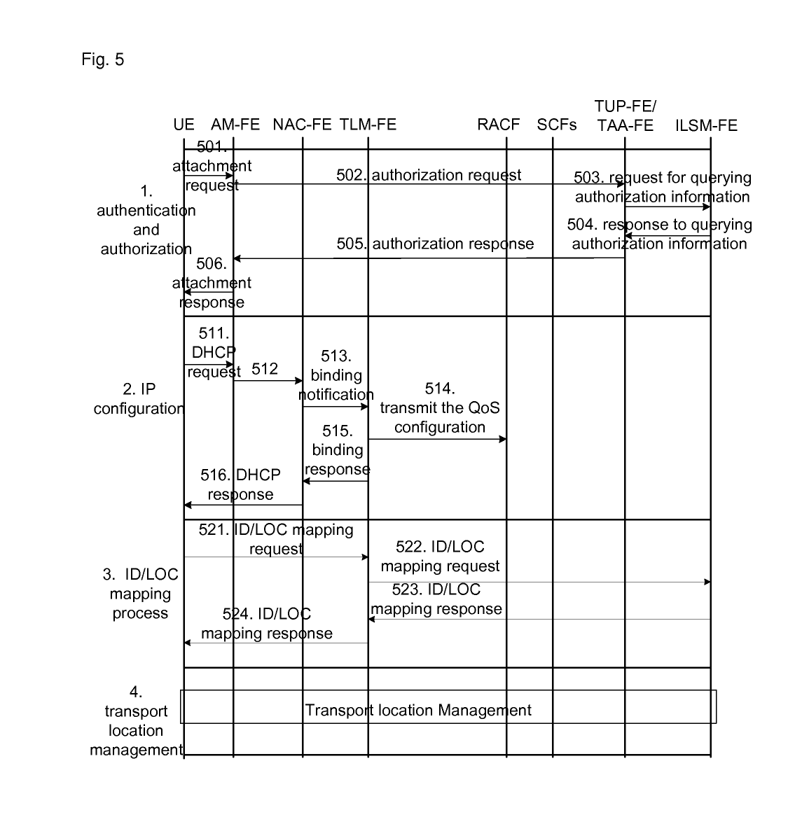

FIG. 5 is a schematic diagram illustrating an ID-Loc-Split terminal attachment process in an NGN system with the terminal initiating a mapping request and with the participation of a gateway. The specific steps are specified as follows.

(1) The authentication and authorization process (steps 501-506): the authentication and authorization process with the participation of a gateway is the same as the authentication and authorization process without the participation of a gateway in Embodiment 1.

(2) The IP address configuration process (steps 511-516): the IP address configuration process with the participation of a gateway is the same as the IP address configuration process without the participation of a gateway in Embodiment 1.

(3) The ID/LOC mapping process (steps 521-524):

Step 521: transmitting an ID/LOC mapping request message from the UE to the TLM-FE, wherein the message includes a new IP address of the UE.

Step 522: forwarding the ID/LOC mapping request message from the TLM-FE to the ILSM-FE.

Step 523: transmitting an ID/LOC mapping response from the ILSM-FE to the TLM-FE after the ILSM-FE performs the binding via mapping between the Host ID and the IP address.

Step 524: transmitting the ID/LOC mapping response message from the TLM-FE to the UE.

(4) The transport location management process:

The processing manner of the transportation location management process with the participation of a gateway is the same as that of the transportation location management process without the participation of a gateway.

### Embodiment 3

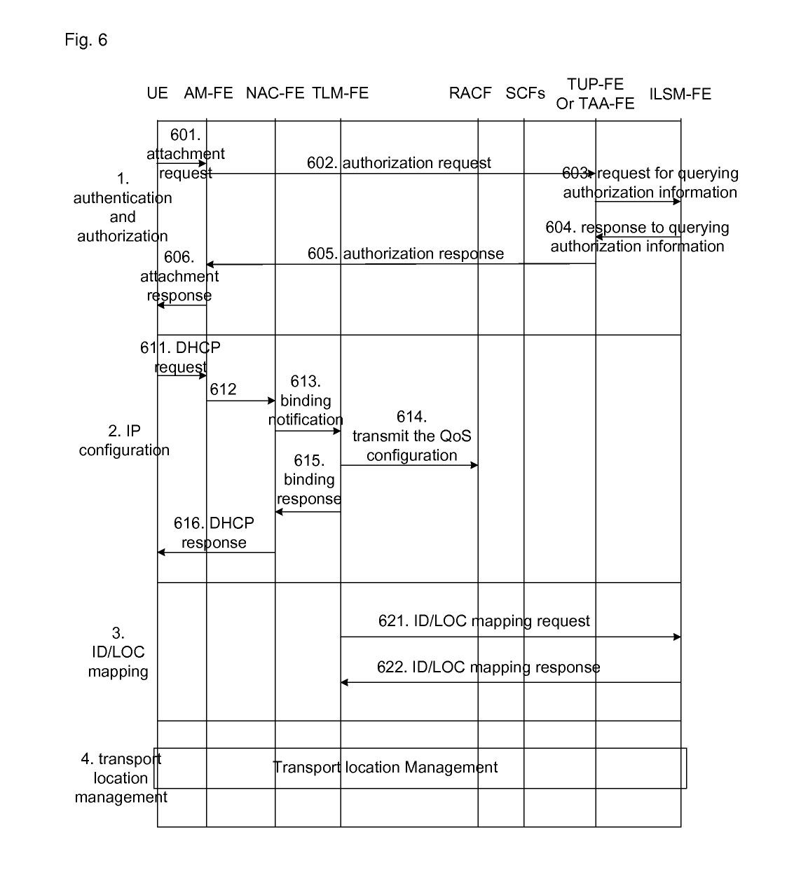

FIG. 6 is a schematic diagram illustrating an ID-Loc-Split terminal attachment process in an NGN system with the network side initiating a mapping request. The specific steps are specified as follows.

(1) The authentication and authorization process (steps 601-606): the authentication and authorization process in this embodiment is the same as the authentication and authorization process without the participation of a gateway in Embodiment 1.

(2) The IP address configuration process (steps 611-616): the IP address configuration process in this embodiment is the same as the IP address configuration process without the participation of a gateway in Embodiment 1.

(3) The ID/LOC mapping process (steps 621-622):

Step 621: transmitting an ID/LOC mapping request from the TLM-FE to the ILSM-FE, wherein the message includes a new IP address of the UE.

Step 622: transmitting an ID/LOC mapping response from the ILSM-FE to the TLM-FE after the ILSM-FE performs the binding via mapping between the Host ID and the IP address.

(4) The transport location management process:

The processing manner of the transport location management process in this embodiment is the same as that of the transport location management process without the participation of a gateway in Embodiment 1.

What are described above are only preferred embodiments of the disclosure, and not intended for limiting the protection scope of the disclosure.

What is claimed is:

1. An attachment method for ID-Loc-Split in an NGN, comprising:
performing a network attachment process for a User Terminal (UE) through an ID-Loc-Split Mapping Function Entity (ILSM-FE), wherein a user identification (Host ID) is used during an authentication and authorization process, the method specifically comprising:
A: performing authentication and authorization to a user identity through the ILSM-FE during the authentication and authorization process;
B: assigning an IP address to the user terminal through an IP address configuration process; and
C: when location of a user changes, responding to an ID/LOC mapping request of the user identification and location identification, and performing a mapping between the Host ID and the IP address by the ILSM-FE.

2. The method according to claim 1, wherein in step A,
when a Transport Authentication and Authorization Functional Entity (TAA-FE) receives an authorization request transmitted from an Access Management Functional Entity (AM-FE), transmitting a request message for querying authorization information from the TAA-FE to the ILSM-FE; wherein the request message for querying authorization information includes security parameters required for authenticating the user identity;
performing authentication and authorization to the Host ID by the ILSM-FE based on the security parameters and transmitting a result of authentication and authorization from the ILSM-FE to the TAA-FE through a response message for querying authorization information.

3. The method according to claim 1, wherein the Host ID is a public key for uniquely identifying a user, and the ILSM-FE performs authentication to the Host ID based on the security parameters.

4. The method according to claim 1, wherein in step C,
initiating the ID/LOC mapping request to the ILSM-FE by the user terminal, wherein the request includes a new IP address of the user; and transmitting a result of mapping from the ILSM-FE to the user terminal after the ILSM-FE performs the mapping between the Host ID and the IP address.

5. The method according to claim 1, wherein in step C,
firstly initiating the ID/LOC mapping request to a TLM-FE by the user terminal, wherein the request includes a new IP address of the user; and forwarding the ID/LOC mapping request from the TLM-FE to the ILSM-FE; and
after the ILSM-FE performs the mapping between the Host ID and the IP address, transmitting a result of mapping to the user terminal through the ILSM-FE.

6. The method according to claim 1, wherein in step C,
initiating the ID/LOC mapping request to the ILSM-FE by the TLM-FE, wherein the request includes a new IP address of the user; transmitting an ID/LOC mapping response from the ILSM-FE to the TLM-FE after the ILSM-FE performs the mapping between the Host ID and the IP address.

7. An attachment system for ID-Loc-Split in an NGN, comprising a User Terminal (UE), an Access Management Functional Entity (AM-FE), a Network Access Configuration Functional Entity (NAC-FE), a Transport Location Management Functional Entity (TLM-FE), a Resource Admission Control Function (RACF), a Service Control Function (SCF) and a Transport Authentication and Authorization Functional Entity (TAA-FE), the system further comprising:
an ID-Loc-Split Mapping Function Entity (ILSM-FE), configured to perform authentication and authorization to a user identification (Host ID) based on security parameters transmitted by the TAA-FE, and perform a mapping between the Host ID and an IP address based on an ID/LOC mapping request transmitted from the UE or the TLM-FE.

8. The system according to claim 7, wherein during a network attachment process, the TAA-FE is configured to transmit a request message for querying authorization information to the ILSM-FE after receiving an authorization request transmitted from the AM-FE, wherein the message includes security parameters required for authenticating user identity; the ILSM-FE is configured to perform authentication and authorization to the Host ID based on the security parameters and transmit a result of authentication and authorization to the TAA-FE through a response message for querying authorization information.

9. The system according to claim 8, wherein the Host ID is a public key for uniquely identifying a user, and the ILSM-FE is configured to perform authentication and authorization to the user identification (Host ID) based on the security parameters included in the request message for querying authorization information.

10. The system according to claim 7, wherein when a location of the user changes,
the user terminal is configured to initiate the ID/LOC mapping request to the ILSM-FE, wherein the request includes a new IP address of the user; the ILSM-FE is configured to transmit a result of mapping after performing the mapping between the Host ID and the IP address; or
the user terminal is configured to firstly initiate the ID/LOC mapping request to the TLM-FE, wherein the request includes a new IP address of the user; the TLM-FE is configured to forward the ID/LOC mapping request to the ILSM-FE; the ILSM-FE is configured to transmit a result of mapping to the user terminal through the ILSM-FE after performing the mapping between the Host ID and the IP address; or
the TLM-FE is configured to initiate the ID/LOC mapping request to the ILSM-FE, wherein the request includes a new IP address of the user; the ILSM-FE is configured to transmit an ID/LOC mapping response to the TLM-FE after performing the mapping between the Host ID and the IP address.

11. The system according to claim 8, wherein when a location of the user changes,
the user terminal is configured to initiate the ID/LOC mapping request to the ILSM-FE, wherein the request includes a new IP address of the user; the ILSM-FE is configured to transmit a result of mapping after performing the mapping between the Host ID and the IP address; or
the user terminal is configured to firstly initiate the ID/LOC mapping request to the TLM-FE, wherein the request includes a new IP address of the user; the TLM-FE is configured to forward the ID/LOC mapping request to the ILSM-FE; the ILSM-FE is configured to transmit a result of mapping to the user terminal through the ILSM-FE after performing the mapping between the Host ID and the IP address; or
the TLM-FE is configured to initiate the ID/LOC mapping request to the ILSM-FE, wherein the request includes a new IP address of the user; the ILSM-FE is configured to transmit an ID/LOC mapping response to the TLM-FE after performing the mapping between the Host ID and the IP address.

12. The system according to claim 9, wherein when a location of the user changes,
the user terminal is configured to initiate the ID/LOC mapping request to the ILSM-FE, wherein the request includes a new IP address of the user; the ILSM-FE is configured to transmit a result of mapping after performing the mapping between the Host ID and the IP address; or
the user terminal is configured to firstly initiate the ID/LOC mapping request to the TLM-FE, wherein the request includes a new IP address of the user; the TLM-FE is configured to forward the ID/LOC mapping request to the ILSM-FE; the ILSM-FE is configured to transmit a result of mapping to the user terminal through the ILSM-FE after performing the mapping between the Host ID and the IP address; or
the TLM-FE is configured to initiate the ID/LOC mapping request to the ILSM-FE, wherein the request includes a new IP address of the user; the ILSM-FE is configured to transmit an ID/LOC mapping response to the TLM-FE after performing the mapping between the Host ID and the IP address.
